(19) United States
(12) Patent Application Publication
(10) Pub. No.: US 2011/0184618 A1
(43) Pub. Date: Jul. 28, 2011

(54) EMERGENCY BRAKING SYSTEM

(76) Inventors: Hidefumi Inoue, Saitama (JP); Kazunari Nemoto, Saitama (JP)

(21) Appl. No.: 13/014,116

(22) Filed: Jan. 26, 2011

(30) Foreign Application Priority Data
Jan. 28, 2010 (JP) 2010-017088

(51) Int. Cl. B60T 8/171

(52) U.S. Cl. 701/70

(57) ABSTRACT

An emergency braking system for a vehicle is designed to be operated upon detecting generation of an electromyogram in a driver. An electromyography is provided on a steering wheel of the vehicle. When the electromyogram detected by the electromyography exceeds a predetermined level, a braking system is operated. The electromyography is designed to obtain the electromyogram at a positive potential electrode, by providing a grip portion of the steering wheel with an earth electrode connected to the ground and the positive potential electrode separated from the ground.

### CROSS-REFERENCE TO RELATED APPLICATION

This application is based on Japanese Patent Application No. 2010-017088 filed on Jan. 28, 2010.

### BACKGROUND OF THE INVENTION

1. Field of the Invention

The present invention relates to an emergency braking system for a vehicle and more particularly, to the system improved in simplification of structure.

2. Description of the Prior Art

Heretofore, various kinds of the systems have been proposed; for example, a system is provided with a millimeter wave radar in a vehicle to detect an obstacle in a forwarding direction, judge a risk of collision, and to apply a brake to the vehicle according to necessity, and another system is provided with a camera, in addition to the radar, in order to further enhance the reliability for detecting an obstacle, as disclosed, for example, in JP-A-2009-282760, JP-A-2009-271766, and etc.

The above conventional systems, however, are complicated in structure, getting costly on the whole vehicle, although they can detect an obstacle and a possibility of collision with a high reliability.

Under the circumstances in pursuit of further safety and reliability of a vehicle, a detection of a possibility of collision with an obstacle and a prevention of the collision at the early stage is getting important and required for a vehicle.

### OBJECT AND SUMMARY OF THE INVENTION

Taking the above into consideration, the object of the invention is to provide an emergency braking system capable of steadily detecting a possibility of collision with a simple structure.

In order to achieve the object of the invention, there is provided an emergency braking system for a vehicle designed to be operated upon detecting generation of an electromyogram in a driver, wherein an electromyography is provided on a steering wheel of the vehicle. When the electromyogram detected by the electromyography exceeds a predetermined judge level, the braking system is operated. The electromyography is designed to obtain the electromyogram at a positive potential electrode, by providing a grip portion of the steering wheel with an earth electrode connected to a ground and the positive potential electrode separated from the ground.

### BRIEF DESCRIPTION OF THE DRAWINGS

The invention is described in detail below in conjunction with the drawing, in which:

FIG. 1 is a structural view showing a basic structure of an emergency braking system according to an embodiment of the invention;

FIG. 2 is a plan view showing the structure of an electromyography used for the emergency braking system shown in FIG. 1;

FIG. 3 is a cross-sectional view showing the cross section taken along the line AA of FIG. 2;

FIG. 4A is a circuit diagram in the first connection example of the electrodes in the electromyography shown in FIG. 2;

FIG. 4B is a circuit diagram in the second connection example of the electrodes in the electromyography shown in FIG. 2;

FIG. 5 is a structural view showing the schematic structure example of the emergency braking system, especially, a hydraulic braking system shown in FIG. 1; and

FIG. 6A is a view for use in describing the timing when a driver recognizes a danger, to judge that the braking operation is needed;

FIG. 6B is a view for use in describing the timing of generating an electromyogram;

FIG. 6C is a view for use in describing the state how the pressurization of a master cylinder proceeds;

FIG. 6D is a view for use in describing the state how the pressure on a brake pedal works;

FIG. 6E is a view for use in describing a change of the liquid pressure in the master cylinder in the case of having the pressurization;

FIG. 6F is a view for use in describing a change of the liquid pressure in the master cylinder in the case of having no pressurization; and

FIG. 6G is a view for use in describing the state how the braking power works.

### DESCRIPTION OF THE PREFERRED EMBODIMENTS

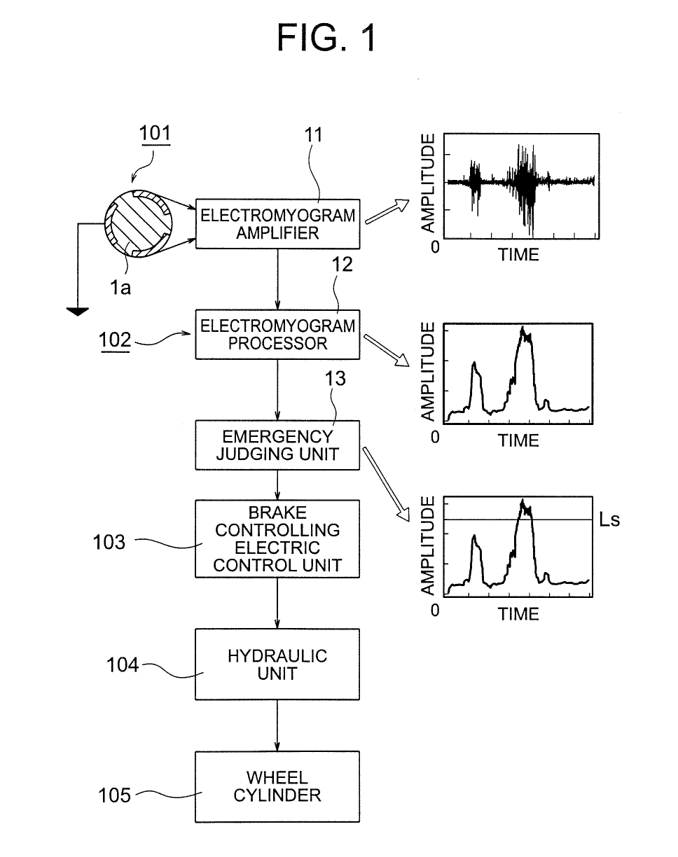

Hereinafter, an embodiment of the invention will be described with reference to FIGS. 1 to 6G.

It will be noted that the members and arrangements described below are not intended to limit the present invention and can be variously modified within the scope of the gist of the present invention.

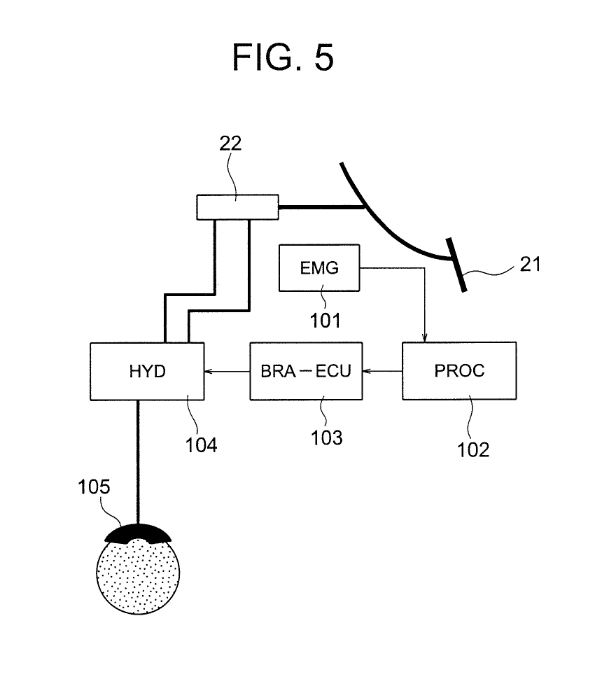

At first, the whole structure of an emergency braking system of the invention will be described with reference to FIGS. 1 and 5.

The emergency braking system according to the embodiment of the invention is suitable for a four wheel vehicle, including an electromyography 101, an electromyogram judging unit 102, a brake controlling electric control unit 103, a hydraulic unit 104, and a wheel cylinder 105 on the whole (refer to FIG. 1).

This emergency braking system is provided together in the usual brake system of the four wheel vehicle. Namely, a brake master cylinder 22 for converting the operational power of a brake pedal 21 into hydraulic pressure is connected to a wheel cylinder 105 through a hydraulic unit 104 by piping. This structure of the braking device has been well known heretofore as a braking system (refer to FIG. 5).

This structure transmits the hydraulic pressure depending on the pressure on the brake pedal 21 to the wheel cylinder 105 through the hydraulic unit 104.

In the hydraulic unit 104, the brake liquid is pressurized in accordance with the generation of an electromyogram, as described later.

In FIG. 5, the “PROC” designates the electromyogram judging unit 102, the “BRA-ECU” designates the brake controlling electric control unit 103, and the “HYD” designates the hydraulic unit 104.

At first, the electromyography 101 according to the embodiment of the invention is provided in a steering wheel 1, and it includes a plurality of positive potential electrodes 2-1 to 2-n formed of conductive material and earth electrodes 3-1 to 3-n/2, in the half number of the positive potential electrodes 2-1 to 2-n, similarly formed of conductive material, as the main components.

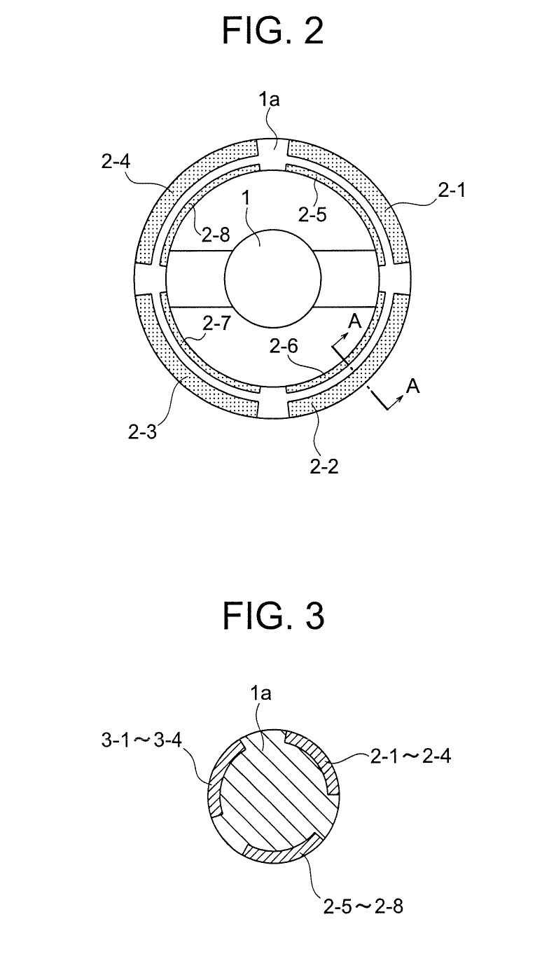

This electromyography 101 will be described with reference to FIGS. 2 to 4B.

For convenience's sake, the following description will be made with n=8.

In the embodiment of the invention, the first to fourth positive potential electrodes 2-1 to 2-4, the fifth to eighth positive potential electrodes 2-5 to 2-8, and the first to fourth earth electrodes 3-1 to 3-4 are respectively arranged in a ring-shaped grip 1a of the steering wheel 1 at proper intervals in the circumferential direction (refer to FIG. 2) and also arranged on the cross section of the grip 1a (FIG. 3) at the intervals of about 120° in the circumferential direction.

The structure of installing the first to eighth positive potential electrodes 2-1 to 2-8 and the first to fourth earth electrodes 3-1 to 3-4 in the grip 1a is not restricted to a specified one but, for example, they may be integrally formed with the grip 1a or they may be installed later.

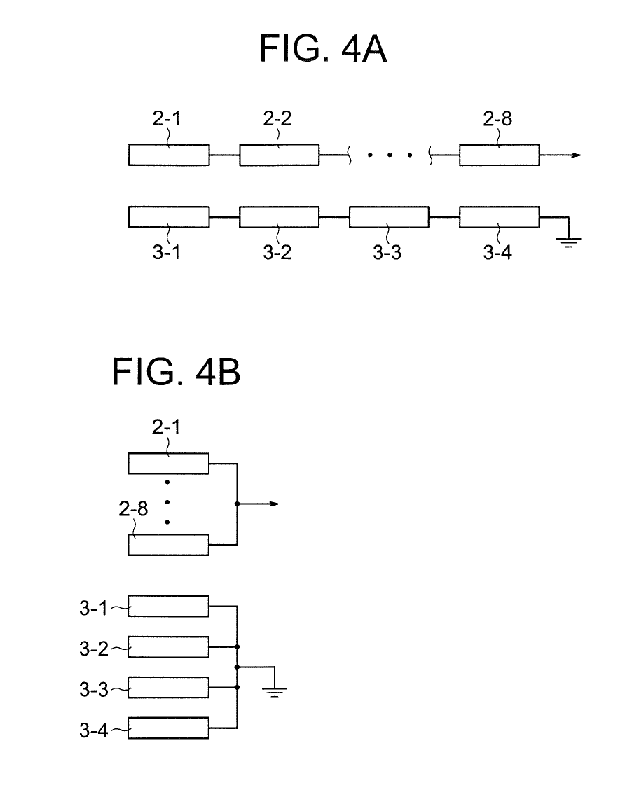

FIGS. 4A and 4B show the electric connection of the first to eighth positive potential electrodes 2-1 to 2-8 and the first to fourth earth electrodes 3-1 to 3-4, and hereinafter, the electric connection of the first to eighth positive potential electrodes 2-1 to 2-8 and the first to fourth earth electrodes 3-1 to 3-4 will be described with reference to FIGS. 4A and 4B.

In a first connection example shown in FIG. 4A, the first to eighth positive potential electrodes 2-1 to 2-8 are connected in series, out of contact with the ground, and connected to an electromyogram amplifier 11 described later, while the first to fourth earth electrodes 3-1 to 3-4 are connected in series to the ground.

The electrode connection is not restricted to this but they may be connected in parallel, for example, like a second connection example shown in FIG. 4B.

Specifically, the first to eighth positive potential electrodes 2-1 to 2-8 are mutually connected in parallel to the electromyogram amplifier 11, while the first to fourth earth electrodes 3-1 to 3-4 are also mutually connected in parallel to the ground.

In the electromyography 101 thus constituted, a driver grasps the grip 1a, thereby into contact with some of the first to fourth earth electrodes 3-1 to 3-4 and some of the first to eighth positive potential electrodes 2-1 to 2-8.

Since the first to fourth earth electrodes 3-1 to 3-4 are connected to the ground, only an electromyogram occurs in the first to eighth positive potential electrodes 2-1 to 2-8, for example, without including any electrocardiogram.

Although the above-mentioned structure example adopts four earth is electrodes 3-1 to 3-4 from the first to the fourth and eight positive potential electrodes 2-1 to 2-8 from the first to the eighth, it is not restricted to this but, for example, four positive potential electrodes may be formed in an arc shape at almost 180° and two earth electrodes may be similarly formed in an arc shape at almost 180°.

Further, the first to fourth positive potential electrodes 2-1 to 2-4 may be integrally formed as one electrode, the fifth to eighth positive potential electrodes 2-5 to 2-8 may be integrally formed as one electrode similarly, and further, the first to fourth earth electrodes 3-1 to 3-4 may be integrally formed as one electrode.

Next, the electromyogram judging unit 102 will be described.

The electromyogram judging unit 102 according to the embodiment of the invention includes an electromyogram amplifier 11, an electromyogram s processor 12, and an emergency judging unit 13.

The electromyogram amplifier 11 is formed to amplify the electromyogram obtained by the electromyography 101 to a level suitable for the posterior signal processing. In FIG. 1, the wave form chart shown at the right of the electromyogram amplifier 11 is a wave form chart schematically showing the electromyogram wave amplified by the electromyogram amplifier 11.

The electromyogram processor 12 is designed to perform necessary signal processing suitable for the judging processing in the posterior emergency judging unit 13 on the electromyogram signal amplified by the electromyogram amplifier 11. More specifically, for example, envelope processing is performed on the electromyogram signal amplified by the electromyogram amplifier 11 to extract only the positive signal. In FIG. 1, the wave form chart shown at the right of the electromyogram processor 12 is a wave form chart schematically showing the output signal waveform of the electromyogram processor 12.

The emergency judging unit 13 judges whether the electromyogram signal processed by the electromyogram processor 12 exceeds a judge level Ls that is a reference level for judging whether a braking is urgently required on a running vehicle; when it exceeds the judge level Ls, the emergency judging unit 13 supplies a signal to that effect to the brake controlling electric control unit 103 (hereinafter, referred to as “brake controlling ECU” as illustrated in FIG. 1). In FIG. 1, the wave form chart shown at the right of the emergency judging unit 13 is a wave form chart showing the above judge level Ls as well as the wave form schematically illustrating the signal entered from the electromyogram processor 12 into the emergency judging unit 13.

The brake controlling ECU 103 is mainly formed, for example, by the well-known microcomputer so as to perform necessary controlling processing for giving a braking power to a vehicle.

The brake controlling ECU 103 receives the liquid pressure of the brake master cylinder 22 detected by a sensor not illustrated and the liquid pressure of the wheel cylinder 105 and upon receipt of these input signals, it generally exerts a braking operation properly while controlling the cylinder pressure of the wheel cylinder 104 through the hydraulic unit 104, according to the pressure amount on the brake pedal (not illustrated).

The hydraulic unit 104 is a hydraulic circuit which transmits the brake liquid pressure corresponding to the pressure on the brake pedal 21 to the wheel cylinder 105, to generate a braking power by the wheel cylinder 105, in which circuit an internal electromagnetic valve (not illustrated) is controlled by the brake controlling ECU 103, to permit a flow of the brake liquid and generation of the pressurization described later. The basic structure is the same as the well-known structure.

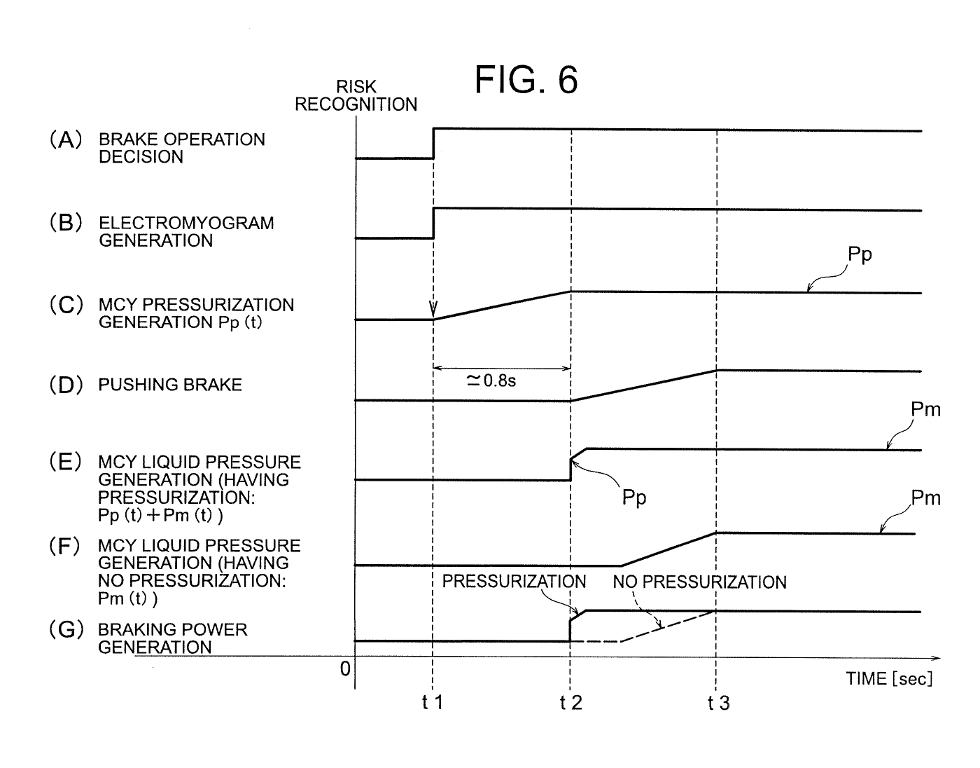

Next, the operation in the above structure will be described with reference to FIGS. 5 and 6A to 6G.

When a driver recognizes an emergency situation to push the emergency brake abruptly during driving a vehicle, for example, when a pedestrian rushes out in front of the vehicle, the driver generally holds the steering wheel 1 tightly, as is often the case.

FIG. 6A schematically shows the timing of the driver's recognition and decision under the above situation; at the point of the time 0, he or she just recognizes such a risk that a pedestrian rushes out in front of the vehicle, and at the time t1, a little later, he or she decides to push the brake operation.

At the instant when the driver decides to push the brake operation, an instruction to the effect is transmitted from his or her brain to muscle, to generate an electromyogram (refer to the point of the time t1 in FIG. 6B), which is received by the electromyography 101 of the steering wheel 1 grasped by the driver and enters into the electromyogram amplifier 11.

Generally, it takes a reaction time of about 0.8 seconds from the driver's decision to push the brake operation to the actual operation to push the brake pedal 21, and after elapse of this reaction time, the brake pedal 21 gets pushed (refer to FIG. 6D).

This reaction time is enough to pressurize the brake liquid pressure according to the electromyogram as described later, and during the reaction time, the electromyogram judging unit 102, the brake controlling electric control unit 103, and the hydraulic unit 104 perform the pressurization processing of the brake liquid pressure as described later.

At first, the electromyogram amplifier 11 amplifies the electromyogram signal entered from the electromyography 101 and supplies the amplified output to the electromyogram processor 12.

Then, the electromyogram processor 12 performs, for example, envelope processing and noise reduction on the input signal and further, the emergency judging unit 13 judges whether the output signal of the electromyogram processor 12 exceeds the judge level Ls or not.

When the emergency judging unit 13 judges that the output signal of the electromyogram processor 12 exceeds the judge level Ls, the emergency judging unit 13 supplies a predetermined electromyogram detected signal corresponding to the effect that the output signal of the electromyogram processor 12 exceeds the judge level Ls, to the brake controlling ECU 103.

Next, upon receipt of the electromyogram detected signal, the brake controlling ECU 103 supplies a predetermined signal for pressurization operation to the hydraulic unit 104.

As the result, the brake liquid of the brake master cylinder 22 is induced into the hydraulic unit 104 and the liquid pressure of the hydraulic unit 104 is raised by a predetermined pressure Pp(t) prior to the raise of the brake liquid pressure caused by the pressure on the brake pedal 21 (refer to FIG. 6C).

The above operations are performed within the above mentioned reaction time.

When a driver starts pushing the brake pedal 21 just after the elapse of the reaction time (refer to the time t2 in FIG. 6D), the liquid pressure of the brake master cylinder 22 is increased according to the pressure on the brake pedal 21; however, since the predetermined pressure Pp(t) is generated in the hydraulic unit 104 as mentioned above, the brake pressure generated by the brake master cylinder 22 becomes the total sum of the pressure Pp(t) and the liquid pressure Pm(t) according to the pressure on the brake pedal 21 (refer to FIG. 6E), which is transmitted to the wheel cylinder 105.

As the result, a braking power can be obtained from the beginning of pushing the brake pedal 21 (refer to FIGS. 6F and 6G), differently from the case of having no pressurization.

In the above mentioned structure, especially, the electromyogram processor 12 and the emergency judging unit 13 can be realized through so-called microcomputer's execution of software; for example, the brake controlling ECU 103 may be used also for the above, to execute the above mentioned necessary processing.

Although the example of applying the invention to the structure having the ordinary brake system has been described in the above mentioned structural example, it is not restricted to this, but for example, it may be applied to a vehicle having a so-called automatic brake which is designed to automatically exert a brake, regardless of a driver's braking operation.

According to the invention, since an electromyogram is used, it is possible to detect a possibility of collision and avoid the collision for sure with a simple structure.

The invention is suitable for a vehicle emergency braking system, because it can get only the electromyogram for sure in a simple structure to generate a quick braking power.

The foregoing relates to a preferred exemplary embodiments of the invention, it being understood that other variants and embodiments thereof are possible within the spirit and scope of the invention, the latter being defined by the appended claims.

1. An emergency braking system for a vehicle designed to be operated upon detecting generation of an electromyogram in a driver, comprising:
an electromyography provided on a steering wheel of the vehicle, which detects the electromyogram in the driver, and when the electromyogram exceeds a predetermined level, the braking system is operated;
a positive potential electrode with which the electromyography obtains the electromyogram; and
a grip portion of the steering wheel provided with an earth electrode connected to a ground, wherein the positive potential electrode is separated from the ground.

2. The emergency braking system according to claim 1, wherein in the grip portion having a circular cross section, the earth electrode is provided at one position and the positive potential electrodes are provided at two positions, each position disposed at intervals of about 120° in a circumferential direction of the steering wheel.

3. The emergency braking system according to claim 2, wherein one or a plurality of the earth electrodes and one or a plurality of the positive potential electrodes are provided in the grip portion of the steering wheel in a circumferential direction.

4. The emergency braking system according to claim 3, wherein the plurality of the earth electrodes and the plurality of the positive potential electrodes provided in the grip portion of the steering wheel in the circumferential direction are connected in series or in parallel.
